(19) United States
(12) Patent Application Publication
(10) Pub. No.: US 2004/0005920 A1
(43) Pub. Date: Jan. 8, 2004

(54) Method, apparatus, and article for reading identifying information from, for example, stacks of chips

(75) Inventors: Richard Soltys, Bellevue, WA (US); Richard Huizinga, Bellevue, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: MindPlay LLC, Bellevue, WA

(21) Appl. No.: 10/457,053

(22) Filed: Jun. 5, 2003

Related U.S. Application Data
(63) Continuation-in-part of application No. 10/358,999, filed on Feb. 4, 2003.
(60) Provisional application No. 60/406,246, filed on Aug. 27, 2002.
(60) Provisional application No. 60/354,730, filed on Feb. 5, 2002.

(51) Int. Cl. A63F 13/00

(52) U.S. Cl. 463/25

(57) ABSTRACT

A device for use with reading wagers that includes but is not limited to an illuminator having at least one emitter of monochromatic light orientable to illuminate a defined wager location; an imager system orientable to receive light from an illuminated object, if any, at the defined wager location; and a symbol identifier coupled to receive image data from the imaging system.

### TECHNICAL FIELD

The disclosure is generally related to the gaming industry, and particularly to the use of machine vision in automating the monitoring of gaming activities, such as wagering.

### BACKGROUND OF THE INVENTION

The performance of machine vision applications is highly dependent on the quality of the image for pattern recognition. Typically, a reference pattern or image library is stored in a computer-readable memory for the purpose of comparing live images to achieve a pattern match. The criteria used for comparison may be color, shape, size or other distinguishing features that clearly identify the object from other objects within the same digital scene. A pattern match is therefore best achieved when the object of interest has unique identifiers for matching purposes as well as for filtering out other potential matches within a digital scene of objects. To achieve the best results, the imaging conditions (e.g., lighting, background) are tightly controlled to limit the many factors affecting the performance of the technology.

The gaming industry presents a unique application for machine vision due to the very dynamic nature of a casino operation. Typically, each gaming table presents a unique visual environment with respect to other gaming tables in the casino. Further complicating the situation is the ever changing visual environment at any given gaming table. For example, constantly varying light conditions occur at a gaming table, for example, caused by nearby signage and/or slot machine displays. Also, the visual background at a table continually changes, for example, as a result of different people that will surround a table over a period of time, the movement of these people, and/or the placement of various items on the gaming table at various times, such as drinks, extra chips, currency and other items.

These and other factors render the casino visual environment almost uncontrollable from a machine vision standpoint. There is generally a need to achieve consistent results from machine vision, and a particular need in the gaming industry for a way to achieve consistent results from machine vision while operating in such an uncontrollable visual environment.

### SUMMARY OF THE INVENTION

A reading system employs directional light to illuminate and item to be read, such as a stack of chips. The reading system may employ light in a non-visible portion of the electromagnetic spectrum, such as the infrared (IR) portion. The reading system may include one or more illumination sources, which in one embodiment are housed by a chip tray. The reading system may include one or more imagers, which in one embodiment are housed by the chip tray. The reading system may employ frequency selective optical lenses and/or filtering such as band pass filtering. The items to be read may have information encoded therein using special frequency selective additives or materials, for example IR absorption additives. Such additives or materials may, for example, take the form of either organic or inorganic pigments or dyes, applied to or incorporated into the edges of a gaming chip.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of one illustrated environment including a reading system, the environment taking the form of gaming played at a gaming table including a chip tray.

FIG. 2 is a front, top, right side isometric view of a chip tray.

FIG. 3 a sectional view of along section line 3 of the chip tray of FIG. 2, to illustrate a number of imagers housed by the chip tray.

FIG. 4 is a top plan view of the gaming table, illustrating the optical coverage of the imagers of FIG. 3.

FIG. 5 a sectional view of along section line 5 of the chip tray of FIG. 2, to illustrate a number of illumination sources housed by the chip tray.

FIG. 6 is a top plan view of the gaming table, illustrating the illumination coverage of the illumination sources of FIG. 5.

FIG. 7 is a schematic diagram of a chip reading system employing overhead lighting to illuminate a chip stack and an imager to capture an image of the illuminated chip stack.

FIG. 8 is a schematic diagram of a chip reading system employing directional, frequency band specific lighting to illuminate a chip stack, and an optical filter and imager to capture an image of the illuminated chip stack.

FIG. 9 is a schematic diagram of a chip reading system employing directional, frequency band specific lighting to illuminate a chip stack, and an imager and electronic filtering to capture an image of the illuminated chip stack.

### DETAILED DESCRIPTION

In the following description, certain specific details are set forth in order to provide a thorough understanding of various embodiments of the invention. However, one skilled in the art will understand that the invention may be practiced without these details. In other instances, well known structures associated with lenses, filters, illumination sources, power sources, scanners, imagers, image processing, and filtering have not been shown or described in detail to avoid unnecessarily obscuring descriptions of the embodiments of the invention.

Unless the context requires otherwise, throughout the specification and claims, which follow, the word “comprise” and variations thereof, such as “comprises” and “comprising” are to be construed in an ‘inclusive’ sense, that is as “including, but not limited to.”

The headings provided herein are for convenience only and do not interpret the scope or meaning of the claimed invention.

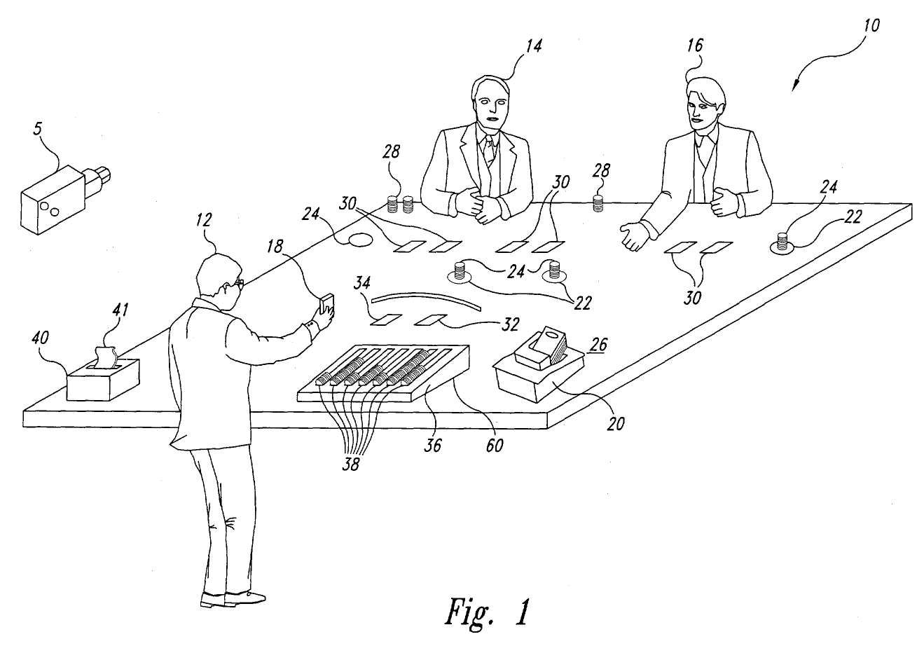

FIG. 1 shows a game of blackjack being played at a gaming table 10 by a game operator or dealer 12 employed by a gaming house or casino and customers or players 14, 16. While blackjack is used as an example, the teachings herein are generally applicable to a variety of wagering games, such as craps, baccarat, poker, wheel of fortune, and roulette to name only a few.

During a game, the dealer 12 removes cards 19 from a card shoe 20. The dealer 12 can individually draw the cards from the card shoe 20, or can remove an entire deck 18 of cards 19 from the card shoe 20 to deal by hand. Many players 14, 16 appreciate the experience of a game where the cards are dealt from a deck 18 held by the dealer 12, rather than being individually drawn from the card shoe 20.

The players 14, 16 place their respective wagers by placing a number of wager chips 22 in wager circles 24 demarcated on a playing surface 26 of the gaming table 10. The chips 22 typically come in a variety of denominations, as is explained in detail below. Players 14, 16 are issued chips in exchange for currency or credit by the casino's tellers. Casino's typically require the use of chips 22 for wagering, rather than actual currency. A player 14 can chose to play multiple hands by placing more than one wager, as shown in FIG. 1. The players 14, 16 will often have a reserve of chips 28 from which to place wagers.

After the players 14, 16 have placed an initial wager of chips 22 in their respective wager circles 24, the dealer 12 deals each player two cards 30 face down, and deals herself one card 32 face down (“hole card”) 32 and one card 34 face up (“show card”) from the deck 18. The players 14, 16 can accept additional cards (“hits”) from the deck 18 as they attempt to reach a total card value of “21 ” without going over, where face cards count as ten points, and Aces can count as either one or eleven points, at the cardholder's option. The dealer 12 also attempts to reach “21” without going over, although the rules typically require the dealer 12 to take a hit when holding a “soft 17.” The players 14, 16 can vary their wagers (chips 22) after the initial cards 30-34 are dealt based on their knowledge of their own hand and the dealer's face up card 34. For example, the player 14, 16 can “hit” or “stand” and may “double down” or “buy insurance.”

At the end of a “hand” or game, the dealer 12 collects the wager chips 22 from losing players and pays out winnings in chips to the winning players. The winnings are calculated as a multiple of a set of odds for the game and the amount of the wager chips 22. The losses are typically the amount of the wager chips 22. The dealer 12 places the collected wager chips 22 or “take” from the losing players into a gaming table bank that takes the form of a chip tray 36. The dealer 12 pays out the winnings using the required number of chips 38 from the chip tray 36. The chip tray 36 generally consists of a number of wells, sized to receive the chips 38 with different wells generally used to contain different value chips. Changes to the contents of the chip tray 36 represent the winnings and loses of the casino (“house”) at the gaming table 10. Thus, maintaining an accurate count of the number and value of the chips 38 in the chip tray 36 can assist the casino in managing its operations. Many casinos permit the dealer 12 to exchange chips for items 41 of value such as currency or other items at the gaming table 10. The dealer 12 deposits the item 41 of value into a drop box 40 at or near the gaming table 10. Periodically, for example at the end of a dealer's shift, the contents of the drop box 40 must be reconciled with contents of the chip tray 36, to ascertain that the correct number and value of chips were distributed.

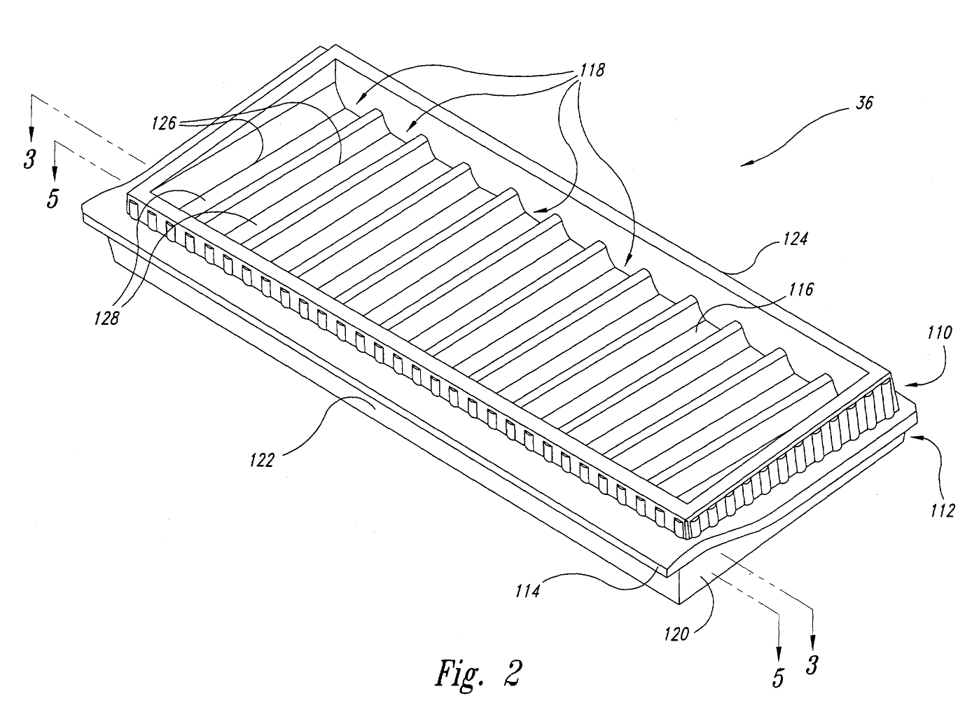

FIG. 2 shows the chip tray 36 in further detail. The chip tray 36 is shown in FIG. 2 as including upper and lower portions 110, 112, respectively, and a shelf 114 separating the upper and lower portions 110, 112. The upper portion 110 includes a chip carrying surface 116 having a number of wells 118 sized and dimensioned to accept the chips 38 (FIG. 1). A side wall 120 extends downwardly from the chip carrying surface 116 and thereabout to form a four-sided enclosure that contains the optical and electrical components of play tracking and chip monitoring subsystems 56. When in use on a gaming table 10, a front portion 122 of the side wall 120 faces the players 14, 16 and a rear portion 124 of the side wall 120 faces the dealer 12 (FIG. 1). The front portion 122 of the side wall 120 is slightly higher than the rear portion 124, and the chip carrying surface 116 slopes slightly downward from the front to rear.

A window 126 runs lengthwise along a bottom of each of the wells 118. Alternatively, the window 126 can run along a side of the well 118. The window 126 includes a tinted shield 128 that protects the inner optical and electrical elements of the play tracking and chip monitoring subsystems 56 from view by the players 14, 16 and provides environmental protection for the components of the subsystems 56.

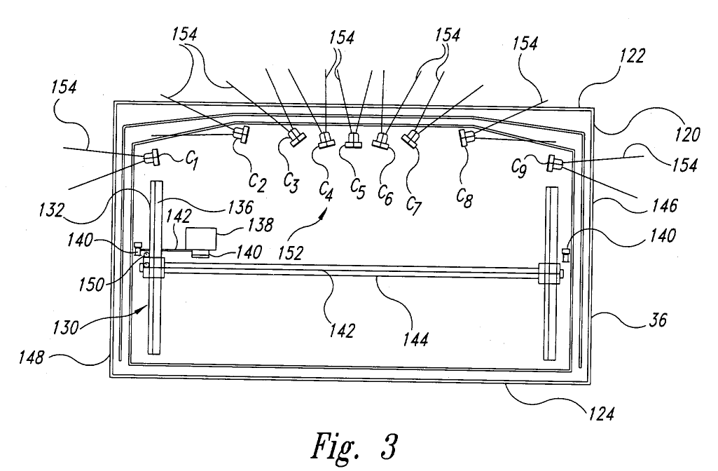

FIG. 3 shows an imager 152 positioned within the enclosure formed by the side wall 120 of the chip tray 36 to provide an approximately 180° view of the playing surface 26 in front of the chip tray 36. In this embodiment, the imager 152 consists of nine area CMOS color sensors C₁-C₉, although the imager 152 can employ a lesser or greater number of sensors. Each of the CMOS color sensors C₁-C₉ have a respective field-of-view 154. The imager 152 can employ other image capture devices, although area CMOS color sensors C₁-C₉ are particular suitable for imaging the chips 38 and cards of the deck 18 on the playing surface 26 of the gaming table 10, such as wager chips 22 and played cards 30-34. The CMOS color sensors C₁-C₉ can each be mounted within a respective aperture 156 formed in the front portion 122 of the side wall 120, below the shelf 114, or can be aligned with a respective one of the apertures 156. The CMOS color sensors C₁-C₉ provide a low angle view of the playing surface 26 (approximately 15°). This permits the CMOS color sensors C₁-C₉ to discern the height of the stacks of chips 22 for each of the players 14, 16, including the edges of individual chips, and the any cards appearing on the playing surface 30-34. The low angle also reduces the effects of shadows, typically associated with overhead lighting. The color sensors C₁-C₉ produce table image data for processing by an appropriate circuitry such as a microprocessor, digital signal processor, or application specific integrated circuit (ASIC).

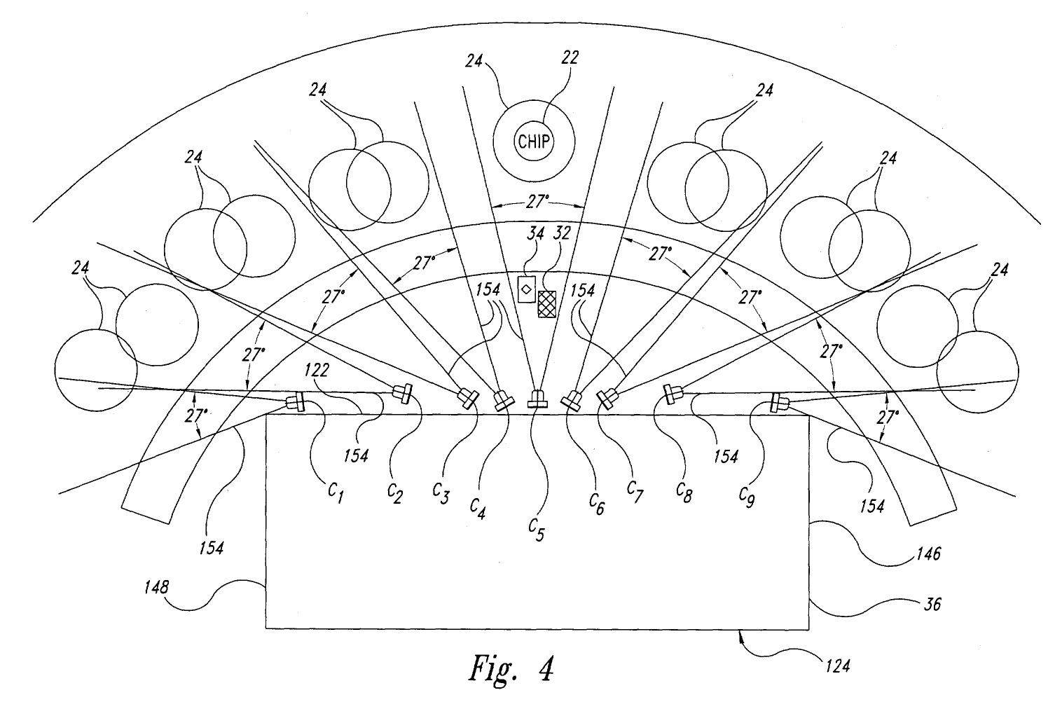

FIG. 4 shows the composite field-of-view formed from the respective fields-of-view 154 of the nine CMOS color sensors C₁-C₉, permits the imager 152 to image substantially the entire playing surface 26 in front of the chip tray 36. Thus, the CMOS color sensors C₁-C₉ image the wager chips 22 of the players 14, 16. By imaging at successive intervals, the play tracking and chip monitoring subsystems 56 can detect changes in the wagers 22.

An opening 60 in the playing surface 26 of the gaming table 10 can receive the chip tray 36, such that the upper portion 110 extends above the playing surface and the lower portion 112 extends below the playing surface of the gaming table 10. The shelf 114 of the chip tray 36 is positioned spaced above the playing surface 26. Positioning the area CMOS color sensors C₁-C₉ below the shelf 114 shields the color sensors C₁-C₉ or apertures 156 from the field-of-view of the players' 14, 16 when the chip tray 36 is on the gaming table 10. The shelf 114 also eliminates glare from overhead light, enhancing the image capturing ability of the CMOS color sensors C₁-C₉.

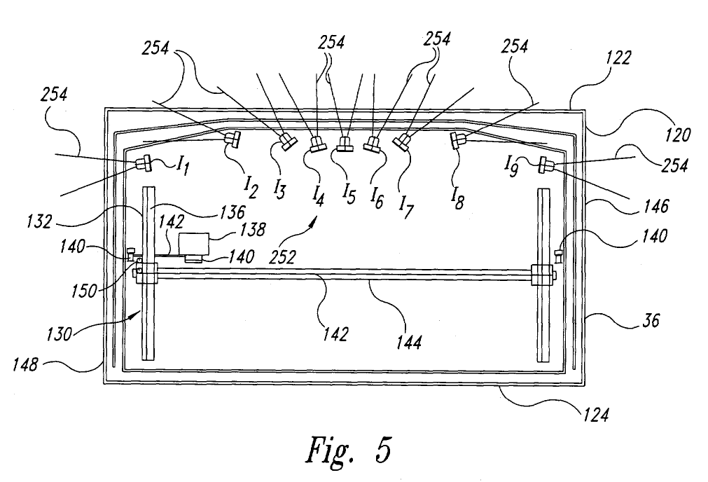

FIG. 5 shows an illuminator 252 positioned within the enclosure formed by the side wall 120 of the chip tray 36 to provide an approximately 180° view of the playing surface 26 in front of the chip tray 36. In this embodiment, the illuminator 152 consists of nine directional IR light emitting diodes (LEDs) I₁-I₉, although the illuminator 152 can employ a lesser or greater number of individual light sources. Each of the IR LEDs I₁-I₉ have a respective field-of-illumination 254. The illuminator 252 can employ other light sources, although directional IR LEDs I₁-I₉ are particular suitable for imaging the wager chips 22. The LEDs I₁-I₉ can each be mounted within a respective aperture formed in the front portion 122 of the side wall 120, below the shelf 114, or can be aligned with a respective one of the apertures. The LEDs I₁-I₉ provide a low angle view of the playing surface 26 (approximately 150). This permits the LEDs I₁-I₉ to illuminate the entire height of the stacks of chips 22 for each of the players 14, 16, including the edges of individual chips. The low angle also reduces the effects of shadows, typically associated with overhead lighting.

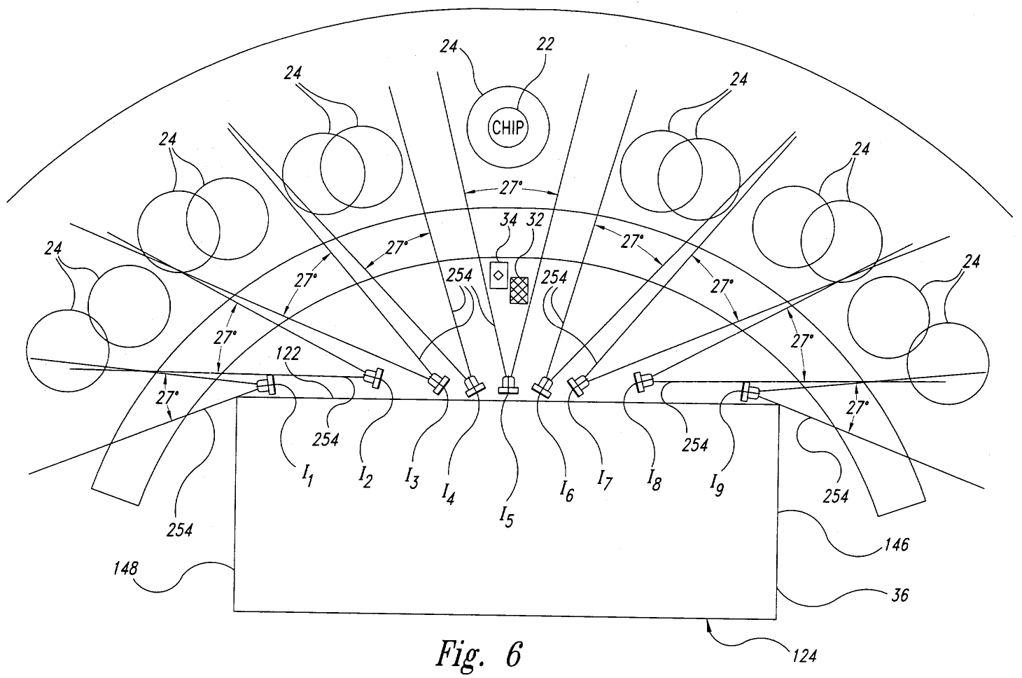

FIG. 6 shows the composite area of illumination formed from the respective fields-of-illumination 254 of the nine IR LEDs I₁-I₉, which permits the imager 152 to image substantially the entire playing surface 26 in front of the chip tray 36. Thus, the LEDs I₁-I₉ illuminate the wager chips 22 of the players 14, 16.

The following concepts significantly improve the results of the table imaging systems such as the MP21™ table imaging system from Mindplay of Bellevue, Wash. These concepts can be used to improve the results of general machine vision applications.

1. IR illumination. By placing an invisible illumination source in the chip tray, line-of-sight to the betting positions and chip stacks, the system achieves a light source independent from the ambient and changing light conditions of a casino floor. This is particularly useful in achieving a controlled lightning environment for pattern matching; for producing shadow free illumination of the target chip stacks and for providing a covert and non-intrusive light source that does not impact the player experience. The directional illumination of chip stacks eliminates the shadow conditions often found from overhead lighting, chip stack overhangs, player hands and other artifacts creating poor imaging conditions. This addresses a significant problem for imaging wagers, particularly where the wagers take the form of stacks of chips. The use of an IR directed source of light provides additional benefits. Most vision recognition techniques rely on color or monochrome contrast of chip edges for detection. The loss of color and/or poor contrast imaging due to shadows and other non-uniformity of lighting results in degraded performance or non-recognition of the object.

2. IR Chips/Absorption. This technique embeds special IR absorption additives as either organic or inorganic pigments or dyes into the edges of a gaming chip. The reading system is comprised of a mono or color CCD/CMOS sensor, a band pass filter selected at the same wavelength of the IR source illumination, a visible cut-off filter and chips encoded with the IR material to selectively absorb IR light in regions that will produce a “black” response independent of the visible color. The result is the sensor will image reflected light off the non-absorption chip edges (“white” response) and read absorption filled edges (“black” response) as a series of chip transitions that identify the value of the chip. This approach achieves improved contrast differences between chip transitions by converting the visible chip colors to a grayscale representation. The absorption pigments can turn any color from the visible response (red/green/blue) to an IR reading of black (absorption). Therefore, the chip has a secret response different then the visible color design as well as improving the machine readable coding (or chip edge) due to increased contrast, better imaging (shadow free illumination)

3. IR Monochromatic Imaging and Optical Object Filtration Technique for Automated Pattern Recognition. This technique is designed to maximize contrast between objects of interest and eliminate, through an optical conversion, objects of non-interest for image processing. The reading system may utilize the following: mono or color CCD/CMOS sensor (any detector whether linear or area scan can be used) Band Pass filter, blocking visible filter (privacy shield only, optional) directional IR light source (chip stack line of sight) and Up converting or Down converting IR phosphors or other materials that exhibit wavelength conversion.

The chips are embedded with a material that exhibits up or down converting wavelength conversion. Essentially, providing a source illumination at one wavelength (as an example 900 nm) the material will emit a wavelength at either a higher or lower wavelength different then the source illumination. When this conversion is combined with a band pass filter at the sensor level only, the resulting image will show only the regions which have the emitted response. All other objects including the reflection of the source illumination will be substantially reduced or eliminated. From an image processing standpoint, this optical method eliminates software recognition filters used for filtering out unwanted objects that could cause confusion with the recognition software. The added security benefit of embedding secret responses only in the invisible region is also of benefit.

Some of the benefits of this approach are: 1) convert lighting into a non-visible portion of the electromagnetic spectrum, such as the IR portion; 2) directional and shadow free illumination of the chip stacks; 3) ultra high contrast of light and dark imaging elements, thus near perfect black/white imaging of contrast regions; and 4) security offered by secret wavelength responses.

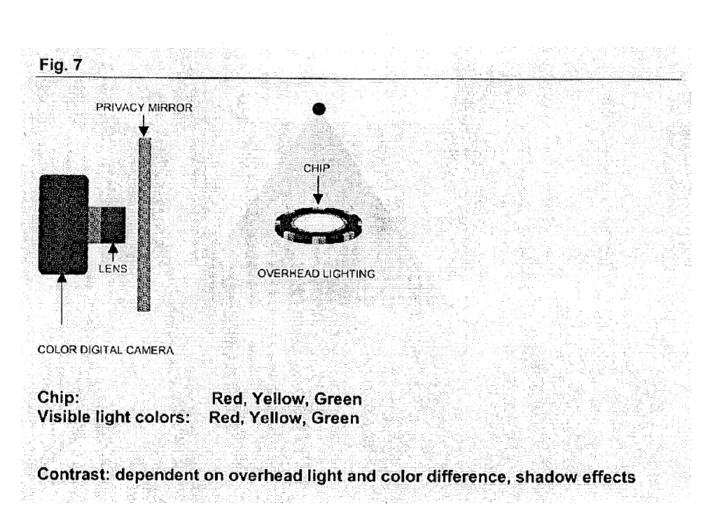

FIG. 7 shows an embodiment employing overhead lighting to illuminate the chip stacks. As discussed above, the illumination may employ frequency selectivity to improve resolution. For example, the illumination may be selected in conjunction with the florescence properties of the material used to mark the chips. Also for example, the illumination may employ a non-visible portion of the electromagnetic spectrum, such as the IR portion to de-emphasize the sensitivity to environmental or ambient lighting.

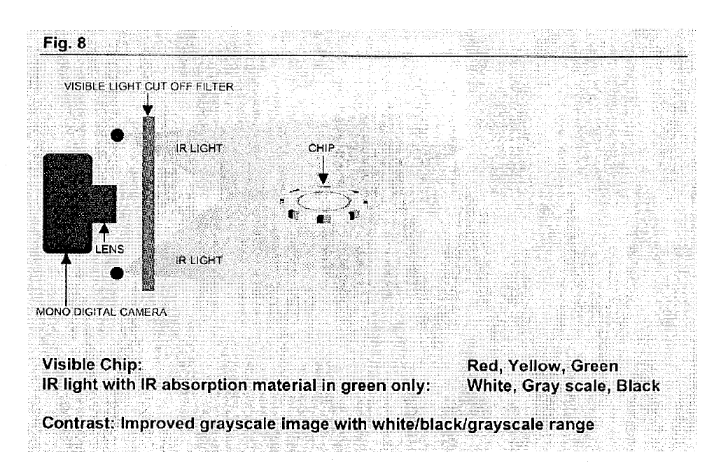

FIG. 8 shows an embodiment employing directional illumination, such as by way of one or more LEDs I₁-I₉ housed in the chip tray 36 (FIGS. 2-6). The embodiment also employs frequency selectively. For example, illumination is provided by LEDs which produce light predominately in the IR portion of the electromagnetic spectrum. A frequency selective optical filter is used for filtering visible light, while passing IR light. Further, the chips employ a frequency selective material to mark the chips, for example an IR absorptive material.

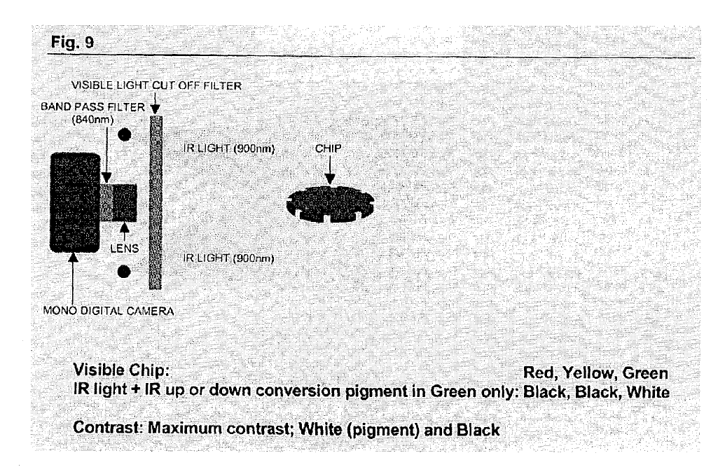

FIG. 9 shows an embodiment similar to that of FIG. 8, but also employing a fluorescence selectivity of the marking material to shift the frequency of the reflected light upward and/or downward. The embodiment further employs a band pass filter in the imager capture circuitry.

The above description sets out a non-intrusive system illuminate and read markings from items, for example stacks of chips. Further details are set out in commonly assigned U.S. patent applications, Application No. 60/130,368, filed on Apr. 21, 1999; application Ser. No. 09/474,858, filed Dec. 30, 1999; Application No. 60/259,658, filed Jan. 4, 2001; application Ser. No. 09/849,456, filed May 4, 2001; Ser. No. 09/790,480, filed Feb. 21, 2001; Application No. 60/300,253, filed Jun. 21, 2001; application Ser. No. 10/061,636, filed Feb. 1, 2002; Application No. 60/296,866, filed Jun. 8, 2001; application Ser. No. 10/017,276, filed Dec. 13, 2001; application Ser. No. 10/017,227, filed Feb. 8, 2002; Application No. 60/354,683, filed Feb. 6, 2002; Application No. 60/354,730, filed Feb. 5, 2002; Application No. 60/406,246, filed Aug. 27, 2002; and application Ser. No. 10/358,999, filed Feb. 4, 2003 which are all incorporated herein by reference in their entirety.

Although specific embodiments of, and examples for, the invention are described herein for illustrative purposes, various equivalent modifications can be made without departing from the spirit and scope of the invention, as will be recognized by those skilled in the relevant art. The teachings provided herein of the invention can be applied to other machine vision systems, not necessarily the exemplary gaming machine vision system generally described above. For example, the reading system can track items other than gaming objects, and/or can track gaming objects other than chips, such as playing cards.

The system can have a different organization than the illustrated embodiment, combining some functions and/or eliminating some functions. The system can employ some of the disclosed automated components for some functions, while relying on manual methods for other functions. The system can be more centralized, or more distributed, as is suitable for the particular gaming environment.

The various embodiments described above can be combined to provide further embodiments. Aspects of the invention can be modified, if necessary, to employ systems, circuits and concepts of the various patents, applications and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all imaging and illumination systems and methods that operate in accordance with the claims. Accordingly, the invention is not limited by the disclosure, but instead its scope is to be determined entirely by the following claims.

1. A method for use with identifying wagers in gaming comprising:
illuminating at least a portion of at least one object representing a wager with monochromatic light;
receiving light from the illuminated portion of the at least one object; and
electronically capturing the received light as an image of the illuminated portion of the at least one object.

2. The method of claim 1 wherein the illuminating at least a portion of at least one object representing a wager with monochromatic light comprises:
emitting the monochromatic light having a wavelength in a non-visible portion of an electromagnetic spectrum.

3. The method of claim 1 wherein the illuminating at least a portion of at least one object representing a wager with monochromatic light comprises:
emitting the monochromatic light having a wavelength in an infrared portion of an electromagnetic spectrum.

4. The method of claim 1 wherein the illuminating at least a portion of at least one object representing a wager with monochromatic light comprises:
energizing at least one light emitting diode oriented toward a wager circle on a gaming table.

5. The method of claim 1 wherein the at least one wager object is a chip and wherein the illuminating at least a portion of at least one object representing a wager with monochromatic light comprises:
energizing at least one light emitter having a light emission frequency that excites a fluorescent property of at least one chip of a bet stack.

6. The method of claim 1 wherein the receiving light from the illuminated portion of the at least one object comprises:
filtering light with an optical filter having a bandpass including at least one wavelength of light emitted by fluorescence of a part of the at least one object.

7. The method of claim 1 wherein the receiving light from the illuminated portion of the at least one object comprises:
capturing light with an image capture device having a reception bandwidth including at least one wavelength of light emitted by fluorescence of a part of the at least one object.

8. A system for use with identifying wagers in gaming comprising:
means for illuminating at least a portion of at least one object representing a wager with monochromatic light;
means for receiving light from the illuminated portion of the at least one object; and
means for electronically capturing the received light as an image of the illuminated portion of the at least one object.

9. A device for use with reading wagers comprising:
an illuminator having at least one emitter of monochromatic light orientable to illuminate a defined wager location;
an imager system orientable to receive light from an illuminated object, if any, at the defined wager location; and
a symbol identifier coupled to receive image data from the imager system.

10. The device of claim 9 wherein the illuminator having at least one emitter of monochromatic light orientable to illuminate a defined wager location comprises:
a directional light emitter having an associated field-of-illumination aimable to encompass at least a part of a defined bet stack location.

11. The device of claim 9, further comprising:
a chip tray having a plurality of directional light emitters, where each directional light emitter of the plurality is respectively aimable to encompass at least one of a plurality of defined bet stack locations.

12. The device of claim 9 wherein the illuminator having at least one emitter of monochromatic light orientable to illuminate a defined wager location comprises:
at least one light emitting diode whose emitted light is substantially nonvisible.

13. The device of claim 9 wherein the imager system orientable to receive light from an illuminated object, if any, at the defined wager location comprises:
an optical filter having a bandpass including at least one wavelength of light emitted by fluorescence of the illuminated object.

14. The device of claim 9 wherein the imager system orientable to receive light from an illuminated object, if any, at the defined wager location comprises:
an image capture device having a reception bandwidth including at least one wavelength of light emitted by fluorescence of the illuminated object.

15. The device of claim 9 wherein the imager system orientable to receive light from an illuminated object, if any, at the defined wager location comprises:
an image capture device having an associated field-of-view aimable to encompass at least a part of the defined wager location.

16. The device of claim 9, wherein the imager system orientable to receive light from an illuminated object, if any, at the defined wager location comprises:
a chip tray having a plurality of image capture devices, where each image capture device of the plurality is respectively aimable to encompass at least one of a plurality of defined bet stack locations.

17. A method for use with identifying wagers in gaming comprising:
illuminating at least a part of a wager with non-visible light;
imaging the part of the wager in response to the illuminating; and
identifying a symbol from the part of the wager in response to the imaging.

18. The method of claim 17 wherein the illuminating at least a part of a wager with non-visible light comprises:
activating at least one monochromatic illuminator oriented toward a part of a bet stack.

19. The method of claim 18 wherein the activating at least one monochromatic illuminator oriented toward a part of a bet stack comprises:
energizing at least one light emitter oriented toward at least one chip of a bet stack.

20. The method of claim 18 wherein the activating at least one monochromatic illuminator oriented toward a part of a bet stack comprises:
energizing at least one light emitter having a light emission frequency keyed to a fluorescent property of at least one chip of a bet stack.

21. The method of claim 18 wherein the activating at least one monochromatic illuminator oriented toward a part of a bet stack comprises:
energizing at least one light emitter having a light emission frequency keyed to at least one wavelength reception property of an imager system.

22. The method of claim 21 wherein the energizing at least one light emitter having a light emission frequency keyed to at least one wavelength reception property of an imager system comprises:
powering a light source having a light emission frequency keyed to a bandwidth of an optical bandpass filter of the imager system.

23. The method of claim 21 wherein the energizing at least one light emitter having a light emission frequency keyed to at least one wavelength reception property of an imager system comprises:
powering a light source having a light emission frequency keyed to a bandwidth of an image capture device of the imager system.

24. The method of claim 17 wherein the imaging the part of the wager comprises:
filtering light with an optical filter having a bandpass keyed to at least one wavelength of the non-visible light.

25. The method of claim 17 wherein the imaging the part of the wager comprises:
filtering light with an optical filter having a bandpass keyed to at least one wavelength of light emitted by fluorescence of a part of a bet stack.

26. The method of claim 17 wherein the imaging the part of the wager comprises:
capturing light with an image capture device having reception bandwidth keyed to at least one wavelength of the non-visible light.

27. The method of claim 17 wherein the imaging the part of the wager comprises:
capturing light with an optical filter having a bandpass keyed to at least one wavelength of light emitted by fluorescence of a part of a bet stack.

28. The method of claim 17 wherein the identifying a symbol from the part of the wager in response to the imaging comprises:
acquiring an image of a gaming table having a bet circle;
selecting an area of the image proximate to the bet circle;
detecting color transitions at least partially in the area;
conforming the color transitions to the area to create area-conformed color transitions;
constructing a working chip template from the area-conformed color transitions;
recalling a first chip denomination representation from a chip denomination representation library, the first chip denomination representation having at least one angle associated with at least one color transition;
applying the first chip denomination representation against the working chip template; and
calculating a first chip score responsive to the applying the first chip denomination representation.

29. A system for use with identifying wagers in gaming comprising:
means for illuminating at least a part of a wager with non-visible light;
means, responsive to the means for illuminating, for imaging the part of the wager; and
means, responsive to the means for imaging, for identifying a symbol from the part of the wager.

30. A device for use with reading wagers comprising:
an illuminator having at least one emitter of substantially non-visible light oriented to illuminate at least a part of an expected wager location;
an imager system responsive to the substantially non-visible light; and
a symbol identifier coupled with the imager system.

31. The device of claim 30 wherein the illuminator having at least one emitter of substantially non-visible light oriented to illuminate at least a part of an expected wager location comprises:
a directional light emitter having an associated field-of-illumination aimed to encompass at least a part of a defined bet stack location.

32. The device of claim 30, further comprising:
a chip tray having a plurality of directional light emitters, where each directional light emitter of the plurality is respectively aimed to encompass at least one of a plurality of defined bet stack locations.

33. The device of claim 32 wherein the plurality of directional light emitters comprises:
at least one light emitting diode whose emitted light is substantially non-visible.

34. The device of claim 30 wherein the imager system responsive to the substantially non-visible light comprises:
an optical filter having a bandpass keyed to at least one wavelength of light emitted by fluorescence of a part of a bet stack.

35. The device of claim 30 wherein the imager system responsive to the substantially non-visible light comprises:
an optical filter having a bandpass keyed to at least one wavelength of the substantially non-visible light.

36. The device of claim 30 wherein the imager system responsive to the substantially non-visible light comprises:
an image capture device having reception bandwidth keyed to at least one wavelength of light emitted by fluorescence of a part of a bet stack.

37. The device of claim 30 wherein the imager system responsive to the substantially non-visible light comprises:
an image capture device having reception bandwidth keyed to at least one wavelength of the substantially non-visible light.

38. The device of claim 30 wherein the imager system responsive to the substantially non-visible light comprises:
an image capture device having an associated field-of-view aimed to encompass at least a part of a defined bet stack location.

39. The device of claim 30, further comprising:
a chip tray having a plurality of image capture devices, where each image capture device of the plurality is respectively aimed to encompass at least one of a plurality of defined bet stack locations.

40. A device for use with wagering comprising:
a wager gaming piece encoded with material that selectively emits non-visible light in response to illuminating non-visible light.

41. The device of claim 40 wherein the material that selectively emits non-visible light in response to illuminating non-visible light comprises:
a material that emits a frequency-shifted component of the illuminating non-visible light.

42. The device of claim 40 wherein the material that selectively emits non-visible light in response to illuminating non-visible light comprises:
a material that emits a selected frequency component of the illuminating non-visible light.
